(19) United States
(12) Patent Application Publication
(10) Pub. No.: US 2024/0154653 A1
(43) Pub. Date: May 9, 2024

(54) NEURAL NETWORK FOR MU-MIMO USER SELECTION

(71) Applicant: Telefonaktiebolaget LM Ericsson (publ), Stockholm (SE)

(72) Inventors: Ulf GUSTAVSSON, Göteborg (SE); Amirashkan FARSAEl, Eindhoven (NL); Alex ALVARADO, Den Bosch (NL); Frans M.J. WlLLEMS, Geldrop (NL); Alireza SHEIKH, Eindhoven (NL)

(73) Assignee: Telefonaktiebolaget LM Ericsson (publ), Stockholm (SE)

(21) Appl. No.: 18/277,200

(22) PCT Filed: Feb. 16, 2021
(86) PCT No.: PCT/EP2021/053718

§ 371 Date: Aug. 14, 2023

(51) Int. Cl. H04B 7/0452; G06N 3/02

(52) U.S. Cl. CPC H04B 7/0452; G06N 3/02

(57) ABSTRACT

A method is disclosed of training a neural network to select users for multi user multiple-input multiple-output (MU-MIMO) communication from a set of potential users. The method comprises providing (to the neural network) a plurality of training data sets, each training data set comprising input data corresponding to a channel realization and output data corresponding to an optimal user selection for the channel realization, and controlling the neural network to analyze the plurality of training data sets to determine a branch weight for each association between neurons of neighboring layers of the neural network, wherein the branch weight is for provision of the output data responsive to the input data. A related method of selecting users for MU-MIMO communication from a set of potential users comprises providing (to a neural network trained as specified above) input data corresponding to an applicable channel, receiving (from the neural network) output data comprising a user selection indication, and selecting users based on the user selection indication. Corresponding apparatuses, neural network, network node and computer program product are also disclosed.

### TECHNICAL FIELD

The present disclosure relates generally to the field of wireless communication. More particularly, it relates to user selection for multi user multiple-input multiple-output (MU-MIMO) communication by utilization of a neural network.

### BACKGROUND

In some scenarios for MU-MIMO, there is a need to select which users from an initial set of potential users should be grouped together for MU-MIMO transmission (e.g., using a same time and/or frequency resource).

Examples include scenarios with a relatively large amount of potential users and/or scenarios where at least one potential user has relatively high channel correlation in relation to at least one other potential user (i.e., the corresponding users are referred to as highly correlated). For example, in line-of-sight (LoS) scenarios for MU massive MIMO with max-min power control, there are some use cases where the channel vectors of some users become highly correlated (i.e., the corresponding users are referred to as highly correlated).

A situation with highly correlated users typically leads to a relatively large detrimental effect on performance metric(s) (e.g., a relatable large reduction in the sum-rate for both linear and nonlinear precoders). To alleviate the detrimental effect on performance metric(s), one or more of the users can be dropped (and rescheduled).

To choose which users to drop (or—correspondingly—to choose which users to keep; i.e., to select users for MU-MIMO), an exhaustive search may be applied to find the optimal dropping strategy for the channel realization (e.g., in terms of performance metric(s)). The exhaustive search approach typically suffers from an extremely high computational complexity.

Alternatively, the spatial correlation among the channel vectors of users can be evaluated and one or more users with spatial correlation higher than a predefined threshold may be dropped. However, this approach typically yields results that are less than optimal (e.g., in terms of performance metric(s)), and the inferiority compared to the optimal dropping strategy may be undesirably large in some situations (e.g., for some practical massive MIMO systems and/or when the ratio between the number of antennas at the transmitter and the number of users is relatively low). Additionally, the process of finding suitable value(s) for the predefined threshold typically requires processing resources (e.g., for simulations and/or measurements).

Therefore, there is a need for alternative (and preferably improved) approaches for selecting users for multi user multiple-input multiple-output (MU-MIMO) communication from an initial set of potential users.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method of training a neural network to select users for multi user multiple-input multiple-output (MU-MIMO) communication from a set of potential users.

The method comprises providing (to the neural network) a plurality of training data sets, each training data set comprising input data corresponding to a channel realization and output data corresponding to an optimal user selection for the channel realization, and controlling the neural network to analyze the plurality of training data sets to determine a branch weight for each association between neurons of neighboring layers of the neural network, wherein the branch weight is for provision of the output data responsive to the input data.

In some embodiments, the input data comprises a channel correlation metric of the channel realization for each user in the set of potential users.

In some embodiments, the channel correlation metric for a user comprises one or more of: a channel filter norm for the user, a channel norm for the user, a channel gain for the user, pair-wise correlations between the user and one or more other users of the set of potential users, and a channel eigenvalue for the user.

In some embodiments, an input layer of the neural network comprises one neuron per element of the channel correlation metric.

In some embodiments, an output layer of the neural network comprises one neuron per selection alternative.

In some embodiments, a selection alternative refers to whether a particular user is selected, or whether a particular collection of users are selected.

In some embodiments, the output data comprises a vector with one element per neuron of the output layer, wherein each element is assigned a binary value defining whether or not the corresponding selection alternative is true for the optimal user selection.

In some embodiments, one or more of: a number of hidden neurons of the neural network, a number of hidden layers of the neural network, and a number of neurons per hidden layer of the neural network is based on one or more of: a number of users in the set of potential users, a maximum number of un-selected users, and a number of MU-MIMO transmit antennas.

In some embodiments, the optimal user selection is based on a performance metric of the set of potential users for the channel realization.

In some embodiments, the performance metric comprises one or more of: a sum-rate, a per-user-rate, an average error rate, a maximum error rate, a per-user error rate, and a sum-correlation.

In some embodiments, the optimal user selection has one or more of: a highest sum-rate, a highest per-user-rate, a lowest average error rate, a lowest maximum error rate, a lowest per-user error rate, and a lowest sum-correlation.

In some embodiments, a user corresponds to a single-antenna user device or to an antenna of a multi-antenna user device.

In some embodiments, the MU-MIMO applies max-min power control.

In some embodiments, the training of the neural network to select users for MU-MIMO communication from a set of potential users comprises machine learning.

A second aspect is a method performed by a neural network, wherein the method is a training method configuring the neural network for selection of users for multi user multiple-input multiple-output (MU-MIMO) communication from a set of potential users.

The method comprises receiving (a plurality of training data sets, each training data set comprising input data corresponding to a channel realization and output data corresponding to an optimal user selection for the channel realization, and analyzing the plurality of training data sets to determine a branch weight for each association between neurons of neighboring layers of the neural network, wherein the branch weight is for provision of the output data responsive to the input data.

A third aspect is a method of selecting users for multi user multiple-input multiple-output (MU-MIMO) communication from a set of potential users.

The method comprises providing—to a neural network trained according to the first and/or second aspect—input data corresponding to an applicable channel, receiving (from the neural network) output data comprising a user selection indication, and selecting users based on the user selection indication.

In some embodiments, the method according to any of the first, second, and third aspects is a computer-implemented method.

A fourth aspect is a computer program product comprising a non-transitory computer readable medium, having thereon a computer program comprising program instructions. The computer program is loadable into a data processing unit and configured to cause execution of the method according to any of the first, second, and third aspects when the computer program is run by the data processing unit.

A fifth aspect is an apparatus for training of a neural network to select users for multi user multiple-input multiple-output (MU-MIMO) communication from a set of potential users.

The apparatus comprises controlling circuitry configured to cause provision (to the neural network) of a plurality of training data sets, each training data set comprising input data corresponding to a channel realization and output data corresponding to an optimal user selection for the channel realization, and control of the neural network for causing the neural network to analyze the plurality of training data sets to determine a branch weight for each association between neurons of neighboring layers of the neural network, wherein the branch weight is for provision of the output data responsive to the input data.

A sixth aspect is an apparatus for selection of users for multi user multiple-input multiple-output (MU-MIMO) communication from a set of potential users.

The apparatus comprises controlling circuitry configured to cause provision—to a neural network trained according to the first and/or second aspect—of input data corresponding to an applicable channel, reception (from the neural network) of output data comprising a user selection indication, and selection of users based on the user selection indication.

A seventh aspect is a neural network configured for selection of users for multi user multiple-input multiple-output (MU-MIMO) communication from a set of potential users, wherein the neural network is trained according to the first and/or second aspect.

An eighth aspect is a network node comprising the apparatus of any of the fifth and sixth aspects, and/or the neural network of the seventh aspect.

A ninth aspect is a server comprising the apparatus of the fifth aspect, and/or the neural network of the seventh aspect.

In some embodiments, any of the above aspects may additionally have features identical with or corresponding to any of the various features as explained above for any of the other aspects.

An advantage of some embodiments is that alternative approaches are provided for selecting users for MU-MIMO communication from an initial set of potential users.

An advantage of some embodiments is that improved approaches are provided for selecting users for MU-MIMO communication from an initial set of potential users.

An advantage of some embodiments is that the computational complexity is reduced (e.g., compared to the exhaustive search approach).

An advantage of some embodiments is that the computational complexity can be controlled (e.g., by variation of applies parameter settings).

An advantage of some embodiments is that no processing resources are needed for finding suitable value(s) for a predefined threshold.

An advantage of some embodiments is that inferiority compared to the optimal dropping strategy (e.g., in terms of performance metric(s)) may be reduced (e.g., compared to approaches dropping user(s) with spatial correlation higher than a predefined threshold).

An advantage of some embodiments is that an outage probability may be reduced (e.g., compared to approaches which apply dropping user(s) with spatial correlation higher than a predefined threshold).

Generally, one or more of the above, or other, advantages may be achieved in a user equipment and/or in a network node, for example.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1A is a flowchart illustrating example method steps according to some embodiments;

FIG. 1B is a flowchart illustrating example method steps according to some embodiments;

FIG. 1C is a flowchart illustrating example method steps according to some embodiments;

FIG. 2 is a schematic drawing illustrating an example neural network according to some embodiments;

FIG. 3 is a schematic drawing illustrating an example channel model according to some embodiments;

FIG. 4 is a schematic drawing illustrating an example communication scenario according to some embodiments;

FIG. 5A is a schematic block diagram illustrating an example apparatus according to some embodiments;

FIG. 5B is a schematic block diagram illustrating an example apparatus according to some embodiments; and

FIG. 6 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described for selection of users for multi user multiple-input multiple-output (MU-MIMO) communication from an initial set of potential users.

Generally, when reference is made herein to selecting users (from an initial set of potential users) for MU-MIMO communication, it should be understood that this task can be equivalently expressed as selecting users to drop from the initial set of potential users.

Also generally, when MIMO is referred to herein, it should be understood to refer to any suitable MIMO approach (e.g., massive MIMO, or other MIMO schemes).

The MU-MIMO applies max-min power control according to some embodiments. It should be understood that, generally, other power control schemes may be applied instead.

Also generally, when the term “algorithm” is used herein, it may be seen as a reference to a principle underlying execution of one or more method steps and/or defining one or more operations of an apparatus.

Some embodiments may be particularly suitable when the ratio between the number of antennas at the transmitter and the number of users is relatively low (e.g., lower than a ratio threshold value).

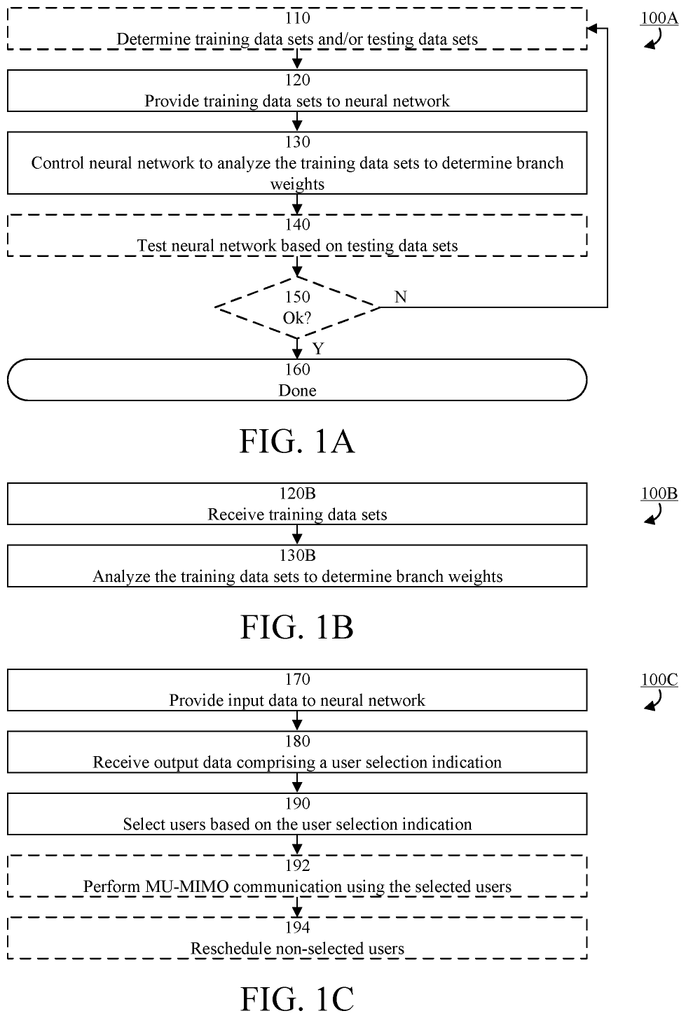

FIG. 1A illustrates an example method 100A of training a neural network to select users for multi user multiple-input multiple-output (MU-MIMO) communication from a set of potential users. The method 100A may, for example, be performed by a neural network manager.

FIG. 1B illustrates an example method 100B corresponding to the method 100A. The method 100B is performed by a neural network and is a training method configuring the neural network for selection of users for MU-MIMO communication from a set of potential users.

Generally, training of a neural network may be seen as a form of machine learning (ML).

The method 100A comprises providing a plurality of training data sets to the neural network, as illustrated by step 120. Correspondingly, the method 100B comprises receiving a plurality of training data sets, as illustrated by step 120B.

Each training data set comprises input data corresponding to a channel realization and output data corresponding to an optimal user selection for the channel realization.

The channel realizations may be any suitable channel realizations (e.g., channel realizations selected randomly from a collection of potential channel realizations). Furthermore, a channel realization may be represented by a channel matrix H according to some embodiments.

The optimal user selection may be achieved in any suitable way. For example, the optimal user selection may be found by exhaustive search among the possible user selections.

The possible user selections may be conditioned on a maximum number of users to be dropped, according to some embodiments.

The maximum number of users that are allowed to be dropped may, for example, be based on one or more of: the number of transmit antennas M, the number of potential users K, and a complexity value. For example, the maximum number of users that are allowed to be dropped may increase with increased number of transmit antennas, and/or increase with increased the number of potential users, and/or increase with increased acceptable complexity.

Furthermore, what constitutes an optimal user selection may be defined in any suitable way. For example, a performance metric may be used to define what constitutes an optimal user selection.

Thus, the optimal user selection may be based on a performance metric of the set of potential users for the channel realization according to some embodiments.

Generally, when a performance metric is referred to herein, it is meant to include any suitable performance metric (or combination of performance metrics). Typically, the performance metric may be based on the channel (e.g., the physical channel only, or a transfer channel including the physical channel as well as influence from one or more components—e.g., channel filters—at the transmitter and/or receiver) and/or on the transmission power (e.g., a maximum transmission power, or an instantaneous transmission power to be used for the MU-MIMO communication).

Example performance metrics include a sum-rate, a per-user-rate, an average error rate, a maximum error rate, a per-user error rate, and a sum-correlation. Example error rates include a bit error rate, a block error rate, and a packet error rate.

In various embodiments, the optimal user selection has one or more of: a highest sum-rate, a highest per-user-rate, a lowest average error rate, a lowest maximum error rate, a lowest per-user error rate, and a lowest sum-correlation; among the possible selections.

The method 100A also comprises controlling the neural network to analyze the plurality of training data sets to determine a branch weight for each association between neurons of neighboring layers of the neural network, as illustrated by step 130. Correspondingly, the method 100B comprises analyzing the plurality of training data sets to determine a branch weight for each association between neurons of neighboring layers of the neural network, as illustrated by step 130B.

The branch weights are for provision of the output data by the neural network, responsive to the input data. It should be understood that the training itself (i.e., the determination of the branch weights) may be performed using any suitable (known or future) approach; based on the training data sets.

In some embodiments, the method 100A also comprises testing the neural network after training, as illustrated by optional step 140. The testing is performed based on testing data sets. Testing may also be referred to as cross validation.

Each testing data set may comprise input data corresponding to a channel realization and output data corresponding to an optimal user selection for the channel realization. For example, the testing data sets may be similar to the training data sets—but for different channel realizations. Alternatively or additionally, each testing data set may be based on measurements (for channel realization and/or user selection).

Typically, the neural network should not be aware that it is being tested. Rather, its operation mode during testing should be identical to its operation mode during live performance, according to some embodiments.

In some embodiments, the method 100A also comprises determining, based on the testing, whether the neural network operates satisfactorily, as illustrated by optional step 150. For example, it may be determined that the neural network operates satisfactorily when the output data of the testing data set(s) coincides with (or is sufficiently similar to) the output data provided by the neural network based on the input data of the testing data set(s).

When it is determined that neural network operates satisfactorily (Y-path out of step 150), the method 100A is completed, as illustrated by step 160. When it is determined that neural network does not operate satisfactorily (N-path out of step 150), the method 100A may return to an earlier step (e.g., step 110) for further training.

In some embodiments, the method 100A may further comprise determining training data sets and/or testing data sets, as illustrated by optional step 110. Step 110 may, for example, comprise selecting channel realization(s) from a collection of potential channel realizations and/or determining corresponding optimal user selection(s).

In some embodiments, the neural network trained based on any of the methods 100A and 100B is applied (only) for scenarios where the ratio between the number of antennas at the transmitter and the number of users is relatively low (e.g., lower than a ratio threshold value).

FIG. 1C illustrates an example method 100C of selecting users for multi user multiple-input multiple-output (MU-MIMO) communication from a set of potential users according to some embodiments.

For example, the method 100C may be performed by a MU-MIMO transmitter device (e.g., a network node; such as a radio access node or a base station) or a device associated with a MU-MIMO transmitter (e.g., a network node; such as a server node).

In step 170, input data corresponding to an applicable channel is provided to a neural network trained according to any of the methods 100A and 1006. For example, an applicable channel may be represented by a channel matrix H. Generally, the applicable channel may be seen as a channel realization.

The channel matrix may be achieved in any suitable way (e.g., provided by a channel estimator).

In step 180, output data is received from the neural network. The output data comprises a user selection indication. For example, the output data may indicate a set of users suitable for MU-MIMO communication.

In step 190, users are selected for MU-MIMO communication based on the user selection indication.

In optional step 192, MU-MIMO communication is performed using the selected users.

In optional step 194, non-selected (dropped) users are rescheduled (e.g., for communication using one or more other communication resources).

It should be noted that, according to some embodiments, optional steps 192 and 194 may be performed in another order than the one illustrated in FIG. 1C, and/or partly in parallel.

Generally, the input data of one or more of: the method 100A (training data set(s) and/or testing data set(s)), the method 100B (training data set(s) and/or testing data set(s)), and the method 100C may comprise a channel correlation metric of the channel realization for each user in the set of potential users.

In some embodiments, the input data of one or more of: the method 100A (training data set(s) and/or testing data set(s)), the method 100B (training data set(s) and/or testing data set(s)), and the method 100C may further comprise the transmission power (e.g., a maximum transmission power, or an instantaneous transmission power).

Generally, when channel correlation is referred to herein, the correlation may be for the physical (over-the-air) channel only, or for a transfer channel including the physical channel as well as influence from one or more components (e.g., channel filters) at the transmitter and/or receiver.

Also generally, when a channel correlation metric is referred to herein, it is meant to include any suitable channel correlation metric (or combination of channel correlation metrics).

Example channel correlation metrics for a user include a channel filter norm for the user, a channel norm for the user, a channel gain for the user, pair-wise (absolute or complex valued) correlations between the user and one or more other users of the set of potential users, and a channel eigenvalue for the user.

Example channel filters include zero-forcing (ZF) filters, conjugate beamforming (CB) filters, minimum mean square error (MMSE) filters, and Tomlinson-Harashima Precoding (THP) filters.

In some embodiments, the any of the methods 100A, 100B, 100C may additionally comprise a step of determining channel filters for the channel realization.

Also generally, the channel correlation metric may be determined based on a channel estimation provided according to any suitable approach.

Also generally, the channel correlation metric may be seen as a metric for spatial correlation between users.

Generally, a user may correspond to a single-antenna user device, a multi-antenna user device, or an antenna of a multi-antenna user device. In the latter case, various approaches are possible. In some approaches, the possible user selections may be conditioned on a restriction condition specifying that when one antenna of a multi-antenna user device is dropped, all other antennas of that multi-antenna user device are also dropped. In some approaches, there is no such restriction condition and it is possible to drop some antenna(s) of a multi-antenna user device while not dropping other antenna(s) of that multi-antenna user device. Dropped antenna(s) of a multi-antenna user device may, for example, be used for diversity reception and/or for achieving beamforming gain.

FIG. 2 schematically illustrates an example neural network 200 according to some embodiments. The neural network 200 may be subject to any of the methods 100A of FIG. 1A and 100C of FIG. 1C. Alternatively or additionally, the neural network 200 may be configured to perform the method 100B of FIG. 1B.

The neural network is configured to receive input data 201, 202, 203 and to provide output data 241, 242, 243, 244.

The input data 201, 202, 203 is received via neurons 211, 212, 213—respectively—of an input layer 210, and the output data 241, 242, 243, 244 is provided via neurons 231, 232, 233, 234—respectively—of an output layer 230. Between the input layer 210 and the output layer 230, the neural network comprises one or more hidden layers 220, wherein each hidden layer comprises a number of hidden neurons 221, 222, 223, 224, 225.

Each neuron of a particular layer of the neural network has a branch to each neuron of the directly subsequent layer of the neural network, exemplified in FIG. 2 by the branch 291 between neurons 213 and 225 and by the branch 292 between neurons 225 and 234. A purpose of the training process is to find branch weights such that the neural network provides, based on the input data of the training data sets, output data that corresponds to (or is sufficiently close to) the output data of the training data sets.

In some embodiments, the input layer 210 of the neural network comprises (e.g., consists of) one neuron per element of the channel correlation metric, and—possibly—one neuron for the transmit power.

In some embodiments, the number of hidden neurons and/or the number of hidden layers and/or the number of neurons per hidden layer may be based on one or more of: a number of users in the set of potential users, a maximum number of un-selected users, and a number of MU-MIMO transmit antennas. For example, the number of hidden nodes may increase with increasing number of potential users and/or with increasing maximum number of un-selected users and/or with increasing number of MU-MIMO transmit antennas. Generally, the number of hidden layers and the number of neurons in each hidden layer are the design parameters, which may provide a performance-complexity tradeoff.

In some embodiments, the output layer 230 of the neural network comprises (e.g., consists of) one neuron per selection alternative.

For example, a selection alternative may refer to whether a particular user is selected (e.g., one output neuron per user; the output data indicating hard selection—e.g., via “0/1” for each user—or soft selection—e.g., via a selection likelihood ratio or probability for each user).

Alternatively, a selection alternative may refer to whether a particular collection of users are selected (e.g., one output neuron per possible set of selected users; the output indicating a hard selection—e.g., via “0/1”, where only a single neuron is indicated for selection—or soft selection—e.g., via a selection likelihood ratio or probability for each possible collection of users).

Thus, the output data of a training (or testing) data set may comprise a vector with one element per neuron of the output layer, wherein each element is assigned a binary value defining whether or not the corresponding selection alternative is true for the optimal user selection.

In an illustrative example, the proposed training and selection methods aim at finding the set of users for MU-MIMO communication (or, correspondingly, finding the set of users that shall be dropped) such that the sum-rate with max-min power control is maximized given that nₘₐₓ is the maximum number of users that are allowed to be dropped.

This illustrative example will now be described with reference to FIGS. 1A-C and 2. It should be understood that any details of this example may be equally applicable to other embodiments, as suitable.

The example assumes that the MU-MIMO transmitter is a base station (BS) with M antennas that serves K single-antenna users, wherein a maximum of nₘₐₓ user may be dropped.

Using machine learning (ML) techniques according to any of methods 100A and 100B may enable finding the set of users to be dropped according to method 100C with reduced complexity compared to using exhaustive search to find the set of users to be dropped.

The user dropping may be modelled as a classification problem. The number of classes may correspond to the number of neurons in the output layer of the neural network.

In an example classification which will be considered in this illustrative example (corresponding to a selection alternative referring to whether a particular collection of users are selected), the number of classes are

$${n}_{out}^{M L} = 1 + ( \begin{matrix}K \\ 1\end{matrix} ) + ( \begin{matrix}K \\ 2\end{matrix} ) … + ( \begin{matrix}K \\ {n}_{max} - 1\end{matrix} ) + ( \begin{matrix}K \\ {n}_{max}\end{matrix} ) .$$

The first class may represent the case where no user is dropped, the next

$$( \begin{matrix}K \\ 1\end{matrix} )$$

classes may represent the cases where only one user is dropped, and so on, until the last

$$( \begin{matrix}K \\ n max\end{matrix} )$$

classes which may represent dropping nₘₐₓ out of K users. The number of neurons of the output layer is equal to the number of classes nₒᵤₜ^{ML} in this example.

The neural network provides a mapping between input data and output data. Hence, the input data should be constructed such that it represents a meaningful metric in relation to which users should be dropped for a given channel realization H. It may be noted that the computational complexity of the neural network is typically directly related to the number of neurons in the input and output layers. Therefore, it may be desired to keep the number of neurons as low as possibly which achieving acceptable results, in order to constrain the computational complexity of the neural network.

Generally, the elements of H may be considered as the input data, since H contains all information required for the dropping algorithm (at least when supplemented by the transmit power P). However, for some scenarios (e.g., massive MIMO), the number of elements of H is relatively high and a reduction of the number of element of the input data may be preferable. Therefore, the pair-wise spatial correlations between users

$${ρ}_{i j} = \frac{{h}_{j}^{H} {h}_{i}}{‖ {h}_{i} ‖ ‖ {h}_{j} ‖}$$

(or the absolute value thereof |ρᵢⱼ|) are used as input data in this example, possibly supplemented by the transmit power P. Thus ρᵢⱼ is one example of an element of the channel correlation metric; a pair-wise complex valued correlation between the user i and another user j of the set of potential users. The pair-wise spatial correlation may be seen as a compressed version of H with

$$( \begin{matrix}K \\ 2\end{matrix} )$$

elements instead of M×K, reducing the number of neurons nᵢₙ^{ML} of the input layer.

Alternatively or additionally, ∥hᵢ∥² may be used as input data (improving performance in the latter case). Using μhᵢ∥² may be particularly beneficial for the case where the users are spread in the entire cell. If ∥hᵢ∥² are sorted before fed to the neural network in the training process, it can lead to a trained neural network with improved performance.

Thus, in the illustrative example, the input data (of any of the methods 100A-C) may comprise |ρᵢⱼ| or ρᵢⱼ (and possibly ∥hᵢ∥²). The BS transmit power P may also be used as an input data element (not needed when, for example, the neural network is trained for a fixed transmit power). The maximum number of users that can be dropped nₘₐₓ may also be used as an input data element (not needed when, for example, the neural network is trained for a fixed maximum number of dropped users).

The output data (of any of the methods 100A-C) may comprise an indication of the set of selected users [symbol] *⊆{1,2, . . . , K} (e.g., a set having the highest sum-rate).

In order to train and test the neural network, training data sets and testing data sets may be generated and used as elaborated on above. For example, a channel realization H may be randomly generated and the corresponding optimal user selection may be found using exhaustive search. For the generated H,

$$( \begin{matrix}K \\ 2\end{matrix} )$$

pair-wise correlations |ρᵢⱼ| (or ρᵢⱼ) may be computed and used as elements of the input data.

The solution of the exhaustive search may be expressed as a “hot vector” to drive the output data in the training process. In this illustrative example, the element of the output data that corresponds selected set according to the exhaustive search is assigned the value “1” and all other elements are assigned the value “0”. For example, when K=4 and nₘₐₓ=2, the number of output neurons becomes nₒᵤₜ^{ML}=11 and the possible hot vectors are: [1 0 0 0 0 0 0 0 0 0 0]—no users dropped, [0 1 0 0 0 0 0 0 0 0 0]—drop user 1, [0 0 1 0 0 0 0 0 0 0 0]—drop user 2, [0 0 0 1 0 0 0 0 0 0 0]—drop user 3, [0 0 0 0 1 0 0 0 0 0 0]—drop user 4, [0 0 0 0 0 1 0 0 0 0 0]—drop users 1 and 2, [0 0 0 0 0 0 1 0 0 0 0]—drop users 1 and 3, [0 0 0 0 0 0 0 1 0 0 0]—drop users 1 and 4, [0 0 0 0 0 0 0 0 1 0 0]—drop users 2 and 3, [0 0 0 0 0 0 0 0 0 1 0]—drop users 2 and 4, and [0 0 0 0 0 0 0 0 0 0 1]—drop users 3 and 4.

To conclude the description of FIGS. 1A-C and 2, a dropping algorithm is provided based on machine learning which does not require a predefined threshold for the spatial correlation of the channel vectors, while trading off complexity against performance. By employing channel realizations and corresponding optimal user selections according to a performance metric (e.g., the sum-rate), a neural network can be trained to select which users shall be included in the MU-MIMO communication and which uses shall be dropped (and rescheduled). The maximum number of users allowed to be dropped may be set in advance.

In a typical example, zero-forcing filtering is assumed, and the achievable downlink sum-rate R with max-min power control is found as

$$R = {log}_{2} ( 1 + \frac{P}{{N}_{0} {\sum }_{k = 1}^{K} {‖ {g}_{k} ‖}^{2}} ) ,$$

where N₀ represents the AWGN power at the users' receivers, and gₖ, k=1,2, . . . , K, denotes ZF filters, G=(g₁, . . . , g_{K})=(H)^{†}wherein H^{†}=H^{H}(HH^{H})⁻¹ for a channel matrix H∈ [symbol] ^{K×M}.

Compared to other sub-optimal selection approaches (e.g., correlation-based solutions), the proposed solution typically achieves better performance (e.g., lower outage probability), and does not require a predefined threshold for the spatial correlation. Furthermore, the complexity of the proposed solution can be controlled (e.g., by varying one or more parameter values, such as the maximum number of users to be dropped).

Compared to the optimal selection approach (exhaustive search), the complexity is reduced considerably by application of the proposed solution.

The complexity of exhaustive search for a given precoder, depends on the corresponding sum-rate for each possible set selected users.

For ZF, the sum-rate is

$$R = {log}_{2} ( 1 + \frac{P}{{N}_{0} {\sum }_{i} {‖ {g}_{i} ‖}^{2}} ) ,$$

and the complexity of finding Σᵢ₌₁^{K}∥gᵢ∥²=trace[(HH^{H})⁻¹] is equal to the complexity of finding the eigenvalues of (HH^{H}), which is O(K³). Therefore, the overall complexity of exhaustive search for ZF is

$${\sum }_{i = 0}^{{n}_{max}} ( \begin{matrix}K \\ i\end{matrix} ) O ( {( K - i )}^{3} ) = O ( {K}^{3 + {n}_{max}} ) .$$

For conjugate beamforming (CB), the bi-section method may be used to find the sum-rate, and the complexity depends on the number of iterations in the bi-section method that is used to find the power control coefficients for CB. At each iteration of the bi-section method, the complexity of finding the estimated power control matrix is O((K−i)³). Thus, after I iterations, the complexity of is O(I(K−i)³), which results in the overall complexity of

$${\sum }_{i = 0}^{{n}_{max}} I ( \begin{matrix}K \\ i\end{matrix} ) O ( {( K - i )}^{3} ) = O ( {IK}^{3 + {n}_{max}} ) .$$

For Tomlinson-Harashima Precoding (THP), the sum-rate is

$$R = {log}_{2} ( 1 + \frac{P}{{N}_{0} {\sum }_{i} {‖ {w}_{i} ‖}^{2}} ) ,$$

where wᵢ is the THP forward filter. Similarly to the ZF case, a summation, i.e., Σᵢ∥wᵢ∥², is relevant for the complexity. However, for THP, the order of users changes the filter wᵢ. Thus (in contrast to the ZF case), to find Σᵢ∥wᵢ∥², the THP filters for each set of dropped users needs to be found separately. This results in the complexity Σᵢ₌₀ⁿ^{ₘₐₓ}(ᵢ^{K})O(M(K−i)²)=O(MK³⁺ⁿ^{ₘₐₓ}).

The complexity of the proposed solution when there is

$${l}_{0} = ( \begin{matrix}K \\ 2\end{matrix} )$$

neurons in the input layer

$$( {l}_{0} = 2 ( \begin{matrix}K \\ 2\end{matrix} ) for THP ) ,$$

l₁ neurons in a single hidden layer and

$${l}_{2} = {n}_{out}^{M L} = 1 + ( \begin{matrix}K \\ 1\end{matrix} ) + ( \begin{matrix}K \\ 2\end{matrix} ) … + ( \begin{matrix}K \\ {n}_{max} - 1\end{matrix} ) + ( \begin{matrix}K \\ {n}_{max}\end{matrix} )$$

neurons in the output layer is 2l₀l₁+2l₁l₂. In the proposed neural network structure according to some embodiments, there is only real multiplication and summation (excluding the activation function). By choosing an appropriate number of neurons in the hidden layer(s), a neural network structure may be found which has less computational complexity compared to the exhaustive search while it can achieve improved performance compared to correlation-based dropping algorithms.

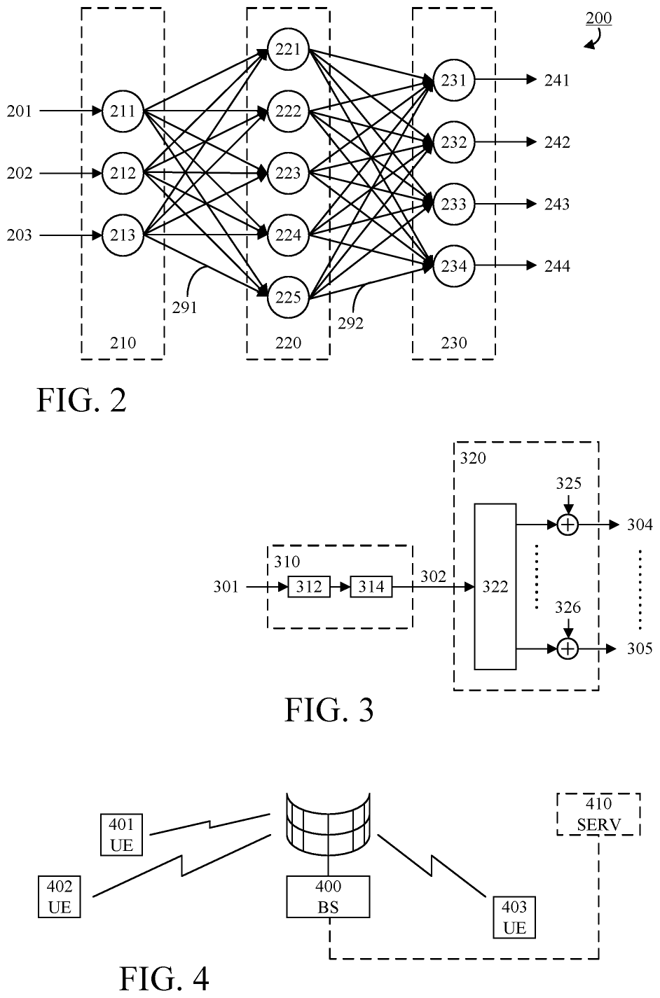

FIG. 3 schematically illustrates an example channel model according to some embodiments, e.g., representing a model for a downlink channel with linear precoding for an M-antenna BS that serves K single-antenna users.

The linear precoding 310 comprises that the zero-mean, uncorrelated, and unit variance symbols s=(s₁, s₂, . . . , s_{K})^{T}∈ [symbol] ^{K×1} provided at 301 are precoded by a diagonal power control matrix D=diag(d) represented by 312 and a linear precoding matrix U∈ [symbol] ^{M×K} with unit-norm column vectors uᵢ represented by 314.

The power control vector is d=(\sqrt{d₁}, \sqrt{d₂}, . . . , \sqrt{d_{K}})^{T}, where dₖ∈R⁺ with k=1, 2, . . . , K are power control coefficients. The radiated power constraint at the BS is Σₖ₌₁^{K} dₖ=P. The precoded vector x∈ [symbol] ^{M×1} provided at 302 is found as x=UDs.

The precoded vector 302 is transmitted through the downlink channel 320; comprising the matrix H=(h₁, h₂, . . . , h_{K})^{T}∈ [symbol] ^{K×M} represented by 322, where hₖ is the channel vector from the BS antennas to user k. The received signal for user k is represented at 304-305 and may be expressed as yₖ=hₖ^{T}x+nₖ=hₖ^{T}uₖ\sqrt{kₖ}sₖ+Σ_{j≠k} hₖ^{T}uⱼ\sqrt{kⱼ}sⱼ+nₖ, where nₖ 325-326 is complex AWGN noise with variance N₀.

Assuming a perfect channel state information for a given channel realization, the signal-to-interference-plus-noise ratio (SINR) for each user can be expressed as:

$${γ}_{k} = \frac{{\vert {h}_{k}^{T} {u}_{k} \vert}^{2} {d}_{k}}{{\sum }_{j \neq k} {\vert {h}_{k}^{T} {u}_{j} \vert}^{2} {d}_{j} + {N}_{0}} .$$

For a given set of filters uₖ, k=1, 2, . . . , K, it may be beneficial to find the coefficients dₖ, k=1, 2, . . . , K that maximize the minimum γₖ among the users (a.k.a., max-min power control), i.e., to find

$$d = arg {max}_{{d}_{1} , {d}_{2} , … , {d}_{K}} {min}_{k} {γ}_{k} .$$

Using max-min power control, uniformly good service may be achieved for all users involved.

For ZF, U is found by modifying the pseudo-inverse of the channel; the ZF filters uₖ are found by normalizing the kth column of the pseudo-inverse of the channel H^{†}=(g₁, g₂, . . . , h_{K})=H^{H}(HH^{H})⁻¹ to have a unit-norm column vector,

$${u}_{k} = \frac{{g}_{k}}{‖ {g}_{k} ‖} .$$

Using the ZF filters, the max-min power control coefficients d are found, which leads to a per-user SINR of

$$γ = \frac{P}{{N}_{0} {\sum }_{k = 1}^{K} {‖ {g}_{k} ‖}^{2}} .$$

Generally, the use of ZF filters (g₁, g₂, . . . g_{K})=H^{H}(HH^{H})⁻¹ may be replaced by use of any other suitable filters; e.g., conjugate beamforming (CB) filters (g₁, g₂, . . . , g_{K})=H^{H}, minimum mean square error (MMSE) filters (g₁, g₂, . . . , g_{K})=H^{H}(αI+HH^{H})⁻¹ where a is an MMSE scaling factor, and Tomlinson-Harashima Precoding (THP) filters.

By employing THP filters with max-min power control, the SINR at the users may be improved compared to the use of ZF filters.

THP uses LCI-decomposition of the channel and the modulo operator to remove multi-user interference. The LCI-decomposition of a channel matrix may be expressed as H=LQ, where L is a lower triangular matrix of size K×M, and Q is an M×M unitary matrix (QQ^{H}=Q^{H}Q=I_{M}). According to THP, the symbols s are encoded to \tilde{s} as:

$${\tilde{s}}_{k} = {[ {s}_{k} - {\sum }_{j = 1}^{k - 1} {b}_{k j} {\tilde{s}}_{j} ]}_{Δ} , k = 1 , … K$$

where [.]_{Δ} is the modulo operator with divisor Δ and bₖⱼ is element (i,j) of a lower triangular matrix B, found by scaling the matrix L as B=LG, where G is a diagonal matrix, which renders the diagonal elements of B to be equal to 1. A vector \tilde{x} is generated by precoding \tilde{s} with a filter matrix W=Q^{H}G. Then, \tilde{x} is adjusted by a scalar β to meet the power constraint ∥x∥²=Pₜₒₜ at the transmitter. The vector x=β\tilde{x} is transmitted through the channel.

FIG. 4 schematically illustrates an example communication scenario according to some embodiments. In the example scenario, a base station (BS) 400 serves three user equipments (UE) 401, 402, 403. As elaborated on above, a user device, such as a UE, may be a single-antenna user device (handled as a user) or may be a multi-antenna user device (wherein each antenna is handled as a user or the device is handled as a single user).

Possibly, the base station is operatively connected to (or otherwise associated with) a server (SERV) 410. The server may, for example, be a central node of the wireless communication network that the base station 400 belongs to, or may be a server external to the wireless communication network (e.g., an Internet server or a cloud server).

The base station 400 and/or the server 410 may comprise an apparatus configured to cause execution of (e.g., configured to execute) one or more of the method steps described in connection with any of FIGS. 1A-C, for selection of users among the UEs 401, 402, 403 for MU-MIMO communication.

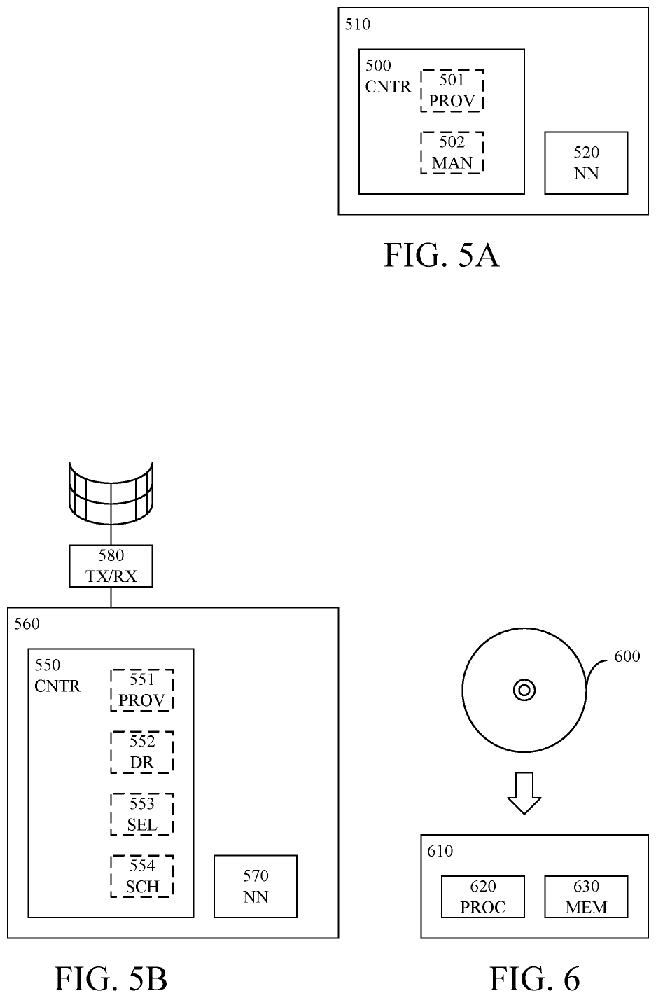

FIG. 5A schematically illustrates an example apparatus 510 according to some embodiments. The apparatus is for training a neural network (NN; compare with 200 of FIG. 2) 520 for selection of users for MU-MIMO communication from an initial set of potential users. The neural network may be comprised in, or otherwise associated with (e.g., connected, or connectable, to) the apparatus 510.

For example, the apparatus 510 may be comprised, or comprisable, in a MU-MIMO transmitter device (e.g., a network node; such as a radio access node or a base station—compare with 400 of FIG. 4) or a device associated with a MU-MIMO transmitter (e.g., a network node; such as a server node—compare with 410 of FIG. 4).

In some embodiments, the apparatus may be configured to cause execution of (e.g., configured to execute) one or more of the method steps described in connection with FIG. 1A.

It should be noted that features mentioned in connection to any of previous Figures may be equally applicable (mutatis mutandis) to the apparatus 510 even if not explicitly mentioned in connection to FIG. 5A.

The apparatus 510 comprises a controller (CNTR; e.g., controlling circuitry or a control module) 500.

The controller 500 is configured to cause provision, to the neural network 520, of a plurality of training data sets, each training data set comprising input data corresponding to a channel realization and output data corresponding to an optimal user selection for the channel realization (compare with step 120 of FIG. 1A). To this end, the controller 500 may comprise, or be otherwise associated with (e.g., connected, or connectable, to) a provisioner (PROV; e.g., provisioning circuitry or a provision module) 501. The provisioner may be configured to provide the plurality of training data sets to the neural network.

The controller 500 is also configured to cause control of the neural network 520 for causing the neural network to analyze the plurality of training data sets to determine a branch weight for each association between neurons of neighboring layers of the neural network, wherein the branch weight is for provision of the output data responsive to the input data (compare with step 130 of FIG. 1A). To this end, the controller 500 may comprise, or be otherwise associated with (e.g., connected, or connectable, to) a training manager (MAN; e.g., managing circuitry or a management module) 502. The training manager may be configured to control the neural network to analyze the plurality of training data sets to determine the branch weights.

FIG. 5B schematically illustrates an example apparatus 560 according to some embodiments. The apparatus is for selection of users for MU-MIMO communication from an initial set of potential users.

For example, the apparatus 560 may be comprised, or comprisable, in a MU-MIMO transmitter device (e.g., a network node; such as a radio access node or a base station—compare with 400 of FIG. 4) or a device associated with a MU-MIMO transmitter (e.g., a network node; such as a server node—compare with 410 of FIG. 4).

In some embodiments, the apparatus may be configured to cause execution of (e.g., configured to execute) one or more of the method steps described in connection with FIG. 1C.

It should be noted that features mentioned in connection to any of previous Figures may be equally applicable (mutatis mutandis) to the apparatus 560 even if not explicitly mentioned in connection to FIG. 5B.

The apparatus 560 comprises a controller (CNTR; e.g., controlling circuitry or a control module) 550.

The controller 550 is configured to cause provision, to a neural network 570, of input data corresponding to an applicable channel (compare with step 170 of FIG. 1C). To this end, the controller 550 may comprise, or be otherwise associated with (e.g., connected, or connectable, to) a provisioner (PROV; e.g., provisioning circuitry or a provision module) 551. The provisioner may be configured to provide the input data to the neural network.

The neural network 570 is trained according to any of the approaches described herein, and may be comprised in, or otherwise associated with (e.g., connected, or connectable, to) the apparatus 560.

The controller 550 is also configured to cause reception, from neural network 570, of output data comprising a user selection indication (compare with step 180 of FIG. 1C). To this end, the controller 550 may comprise, or be otherwise associated with (e.g., connected, or connectable, to) an output data receiver (DR; e.g., data receiving circuitry or a data reception module) 552. The output data receiver may be configured to receive the output data from the neural network.

The controller 550 is also configured to cause selection of users based on the user selection indication (compare with step 190 of FIG. 1C). To this end, the controller 500 may comprise, or be otherwise associated with (e.g., connected, or connectable, to) a user selector (SEL; e.g., selecting circuitry or a selection module) 553. The selector may be configured to select users based on the user selection indication.

The controller 550 may be further configured to cause performance of MU-MIMO communication (compare with step 192 of FIG. 1C). To this end, the controller 550 may comprise, or be otherwise associated with (e.g., connected, or connectable, to) a transceiver (TX/RX; e.g., transceiving circuitry or a transceiver module) 580. The transceiver may be configured to perform the MU-MIMO communication.

The controller 550 may be further configured to cause rescheduling of non-selected users (compare with step 194 of FIG. 1C). To this end, the controller 550 may comprise, or be otherwise associated with (e.g., connected, or connectable, to) a scheduler (SCH; e.g., scheduling circuitry or a scheduler module) 554. The scheduler may be configured to reschedule non-selected users.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device, a server, or a network node.

Embodiments may appear within an electronic apparatus (such as a wireless communication device, a server, or a network node) comprising arrangements, circuitry, and/or logic according to any of the embodiments described herein. Alternatively or additionally, an electronic apparatus (such as a wireless communication device, a server, or a network node) may be configured to perform methods according to any of the embodiments described herein.

According to some embodiments, a computer program product comprises a tangible, or non-tangible, computer readable medium such as, for example a universal serial bus (USB) memory, a plug-in card, an embedded drive or a read only memory (ROM). FIG. 6 illustrates an example computer readable medium in the form of a compact disc (CD) ROM 600. The computer readable medium has stored thereon a computer program comprising program instructions. The computer program is loadable into a data processor (PROC; e.g., data processing circuitry or a data processing unit) 620, which may, for example, be comprised in a wireless communication device, a server, or a network node 610. When loaded into the data processor, the computer program may be stored in a memory (MEM) 630 associated with or comprised in the data processor. According to some embodiments, the computer program may, when loaded into and run by the data processor, cause execution of method steps according to, for example, any of the methods illustrated in FIGS. 1A, 1B and 1C, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method of training a neural network to select users for multi user multiple-input multiple-output, (MU-MIMO) communication from a set of potential users, the method comprising:
providing, to the neural network, a plurality of training data sets, each training data set comprising input data corresponding to a channel realization and output data corresponding to an optimal user selection for the channel realization; and
controlling the neural network to analyze the plurality of training data sets to determine a branch weight for each association between neurons of neighboring layers of the neural network, wherein the branch weight is for provision of the output data responsive to the input data.

2. A method performed by a neural network, wherein the method is a training method configuring the neural network for selection of users for multi user multiple-input multiple-output, (MU-MIMO) communication from a set of potential users, the method comprising:
receiving a plurality of training data sets, each training data set comprising input data corresponding to a channel realization and output data corresponding to an optimal user selection for the channel realization; and
analyzing the plurality of training data sets to determine a branch weight for each association between neurons of neighboring layers of the neural network, wherein the branch weight is for provision of the output data responsive to the input data.

3-18. (canceled)

19. A computer program product comprising a non-transitory computer readable medium, having thereon a computer program comprising program instructions, the computer program being loadable into a data processing unit and configured to cause execution of the method according to of claim 1 when the computer program is run by the data processing unit.

20. An apparatus for training of a neural network to select users for multi user multiple-input multiple-output, (MU-MIMO) communication from a set of potential users, the apparatus comprising controlling circuitry configured to cause:
provision, to the neural network, of a plurality of training data sets, each training data set comprising input data corresponding to a channel realization and output data corresponding to an optimal user selection for the channel realization; and
control of the neural network for causing the neural network to analyze the plurality of training data sets to determine a branch weight for each association between neurons of neighboring layers of the neural network, wherein the branch weight is for provision of the output data responsive to the input data.

21. The apparatus of claim 20, wherein the input data comprises a channel correlation metric of the channel realization for each user in the set of potential users.

22. The apparatus of claim 21, wherein the channel correlation metric for a user comprises:
a channel filter norm for the user;
a channel norm for the user;
a channel gain for the user;
pair-wise correlations between the user and one or more other users of the set of potential users; and/or
a channel eigenvalue for the user.

23. The apparatus of claim 21, wherein an input layer of the neural network comprises one neuron per element of the channel correlation metric.

24. The apparatus of claim 20, wherein an output layer of the neural network comprises one neuron per selection alternative.

25. The apparatus of claim 24, wherein a selection alternative refers to whether a particular user is selected, or whether a particular collection of users are selected.

26. The apparatus of claim 24, wherein the output data comprises a vector with one element per neuron of the output layer, wherein each element is assigned a binary value defining whether or not the corresponding selection alternative is true for the optimal user selection.

27. The apparatus of claim 20, wherein
a number of hidden neurons of the neural network, a number of hidden layers of the neural network, and/or a number of neurons per hidden layer of the neural network is based on a number of users in the set of potential users, a maximum number of un-selected users, and/or a number of MU-MIMO transmit antennas.

28. The apparatus of claim 20, wherein the optimal user selection is based on a performance metric of the set of potential users for the channel realization.

29. The apparatus of claim 28, wherein the performance metric comprises: a sum-rate, a per-user-rate, an average error rate, a maximum error rate, a per-user error rate, and/or a sum-correlation.

30. The apparatus of claim 28, wherein the optimal user selection has: a highest sum-rate, a highest per-user-rate, a lowest average error rate, a lowest maximum error rate, a lowest per-user error rate, and/or a lowest sum-correlation.

31. An apparatus for selection of users for multi user multiple-input multiple-output, (MU-MIMO) communication from a set of potential users, the apparatus comprising controlling circuitry configured to cause:
provision, to a neural network trained according to the method of claim 1, of input data corresponding to an applicable channel;
reception, from the neural network, of output data comprising a user selection indication; and
selection of users based on the user selection indication.

32. The apparatus of claim 31, wherein the input data comprises a channel correlation metric of the applicable channel for each user in the set of potential users.

33. The apparatus of claim 32, wherein the channel correlation metric for a user comprises:
a channel filter norm for the user;
a channel norm for the user;
a channel gain for the user;
pair-wise correlations between the user and one or more other users of the set of potential users; and/or
a channel eigenvalue for the user.

34. The apparatus of any of claim 20, wherein a user corresponds to a single-antenna user device or to an antenna of a multi-antenna user device.

35. The apparatus of any of claim 20, wherein the MU-MIMO applies max-min power control.

36. The apparatus of claim 20, wherein the training of the neural network to select users for MU-MIMO communication from a set of potential users comprises machine learning.

37-41. (canceled)
